(19) United States
(12) Patent Application Publication
(10) Pub. No.: US 2007/0119781 A1
(43) Pub. Date: May 31, 2007

(54) Apparatus and method for enhanced hemodialysis performance

(76) Inventors: Zhongping Huang, West Chester, PA (US); William Herman Van Geertruyden, Conshohocken, PA (US)

Correspondence Address: PILLSBURY WINTHROP SHAW PITTMAN, LLP, P.O. BOX 10500, MCLEAN, VA, 22102, US

(21) Appl. No.: 11/540,705

(22) Filed: Oct. 2, 2006

Related U.S. Application Data
(60) Provisional application No. 60/722,404, filed on Oct. 3, 2005.

(51) Int. Cl. B01D 61/00

(52) U.S. Cl. 210/645; 210/646; 210/321.89; 210/321.87

(57) ABSTRACT

A dialyzer module utilizing a nano-porous ceramic membrane for enhanced hemodialysis performance, and a method for manufacturing the same, are provided. The dialyzer module may be utilized in an extracorporeal blood circuit together with pumps, monitors, and/or other components used for dialysis therapy. The one or more nano-porous ceramic tubes that serve as the hemodialysis membrane may comprise aluminum oxide (alumina) or titanium oxide (titania) tubes manufactured by the anodization of aluminum (Al) or titanium (Ti) tubes in an appropriate acid solution. The nano-porous ceramic tubes may be produced with a nano-porous wall structure having an average pore diameter of approximately five to ten nanometers (run). The nano-porous ceramic tubes exhibit a uniform pore size, uniform pore distribution, high porosity, and high hydraulic conductivity, enabling the removal of more middle and large molecular weight solutes to achieve a performance more comparable to that of an actual kidney while, at the same time, reducing the undesirable loss of important macromolecules such as albumin.

### CROSS-REFERENCE TO RELATED APPLICATIONS

This Application claims priority to U.S. Provisional Patent Application Ser. No. 60/722,404, filed Oct. 3, 2005, which is incorporated herein by reference in its entirety.

### STATEMENT REGARDING FEDERALLY SPONSORED RESEARCH OR DEVELOPMENT

This invention was made with U.S. Government support under Contract No. 1 R41 DK074254-01, awarded by The National Institutes of Health. The U.S. Government has certain rights in this invention.

### FIELD OF THE INVENTION

The invention relates generally to dialyzers used in hemodialysis/artificial kidneys, and more particularly to a dialyzer module utilizing a nano-porous ceramic membrane for enhanced hemodialysis performance, and a method for manufacturing the same.

### BACKGROUND OF THE INVENTION

The two major functions performed by the human kidneys are the excretion of the waste products of bodily metabolism, and the regulation of the concentrations of most of the constituents of the body's fluids. Hemodialysis, a medical procedure that uses a machine (e.g., a dialyzer) to filter waste products from the bloodstream and restore the blood's normal components, is often a necessary and inconvenient form of treatment for those patients with end-stage renal disease or other kidney disorders.

Generally, hemodialysis comprises directing blood flow through an extracorporeal blood circuit, wherein arterial blood drawn from the body is passed through a dialyzer (for filtering) prior to being returned to the venous system of the patient. Hollow-fiber dialyzers and plate dialyzers are two types of dialyzers that may be utilized in an extracorporeal blood circuit during hemodialysis. A hollow-fiber dialyzer typically comprises bundles of capillary tubes through which blood travels, while a plate dialyzer generally comprises membrane sheets “sandwiched” in a parallel-plate configuration.

Within a dialyzer, blood from a patient runs through a plurality of hollow fibers contained within a plastic module (or housing). Each hollow fiber, or membrane, typically comprises a semi-permeable tube having a non-uniform thickness as well as non-uniform pore sizes and pore distribution. Unmodified cellulosic membranes, modified cellulosic membranes, and synthetic polymer membranes are three examples of membranes currently utilized in hemodialysis. These membranes may produced via the wet spinning process, as understood by those having skill in the art.

Membranes play an important role in mass transfer during hemodialysis. For example, a dialysate solution is typically introduced into the housing where it flows external to the hollow fibers (or membranes). The dialysate solution may, for example, comprise a mixture of electrolytes such as sodium, potassium, calcium, magnesium, chloride, acetate and dextrose. As blood flows through the hollow fibers, toxins are removed from the blood via diffusive and convective transport. For instance, during hemodialysis, uremic solutes transfer from the blood side to the dialysate side of a membrane wall. Although the uremic solutes that are responsible for uremic toxicity are still in question due to a lack of analytical techniques, they are usually classified into three groups based on their molecular weights (MW). Low molecular solutes have MW less than 500 Daltons (Da). Examples include urea (60 Da) and creatinine (113 Da).

Middle MW solutes, such as vancomycin, have MW ranging from 500 to 5,000 Da; and large MW solutes have MW greater than 5,000 Da. Parathyroid hormone (9425 Da) and β2-Microglobulin (˜ 11,800 Da) are two examples of large MW solutes.

Usually, low MW solutes and some middle MW solutes may be transferred across a membrane via diffusion. Those having skill in the art recognize that the diffusive properties of a dialysis membrane are determined mainly by porosity (pore density) and pore size. Based on the cylindrical pore model, membrane porosity is directly proportional to both the number of pores and the square of the pore radius (r²). Therefore, diffusive permeability is strongly dependent on pore size. Past studies suggest a direct relationship between delivered urea-based hemodialysis (HD) dosage and patient outcome. Since the elimination of low-molecular weight (MW) nitrogenous waste products is mainly by diffusion through the dialysis membrane, higher porosity will achieve better elimination of these uremic toxins or, in other words, it may deliver a high HD dose in the same amount of time.

Studies also suggest that current diffusion-based therapies may be limited in their ability to adequately remove toxins. These studies suggest the need for alternative chronic dialysis approaches, an example of which is convective therapies. Accordingly, an emerging trend in hemodialysis is the increasing use of convective therapies such as, for example, hemofiltration (HF) and hemodiafiltration (HDF). This is largely because, in comparison with high-flux HD, these convective therapies provide significantly higher clearances of relatively large uremic solutes (e.g., β2-Microglobulin), and improved hemodynamic stability.

The determinants of convective solute removal are primarily the sieving properties of the membrane used and the ultrafiltration rate. The mechanism by which convection occurs is termed solvent drag. If the molecular dimensions of a solute are such that transmembrane passage occurs to some extent, the solute is swept (“dragged”) across the membrane in association with ultrafiltered plasma water.

The non-uniformity of pore size and pore distribution of current hemodialysis membranes tends to result in the low efficiency of uremic solute removal, as well as the undesirable loss of macromolecules such as albumin (an important blood component) during hemodialysis. Typical polymer and cellulosic membranes offer a tube wall morphology that is tortuous in nature and is non-linear. Rather, the polymer and cellulose based membrane tube walls are more sponge-like in morphology. In some cases, there are polymer membranes that have an engineered structure such that the porosity changes from the interior tube wall surface to the exterior tube wall surface. Despite an improved efficiency in selective solute removal, the basic morphology of the membrane remains sponge-like and therefore has a non-uniform pore structure and size.

In addition to the known deficiencies of existing hemodialysis membranes, additional drawbacks exist with regard to the configuration of known dialyzer modules (or housings). For example, current dialyzer characteristics that influence mass transfer include fiber packing density, fiber undulation (also known as crimping), and the presence or absence of spacer yarns. The non-optimized fiber packing density common in current dialyzers often results in the channeling of dialysate at standard flow rates. From a physical perspective, the interior of a densely-packed fiber bundle may create a path of relatively large resistance for dialysate solution, while the periphery of the densely-packed fiber bundle becomes a path of least resistance. An inwardly-situated hollow fiber in a densely-packed fiber bundle cannot participate in diffusive mass exchange if it is not in contact with the dialysate solution.

Another current dialyzer characteristic that influences hollow fiber perfusion with dialysate is fiber bundle spacing, which determines fiber packing density. Dialysate solution may be unable to perfuse the area between adjacent fibers that are spatially too close to one another (or that may be touching one another). These represent yet additional drawbacks of known dialyzers. As is the case for non-optimized packing density, this reduces the effective membrane surface area available for mass exchange.

Current dialyzers are often reused due to their high cost. The repeat disinfection of dialysis membranes, however, tends to negatively impact dialysis performance. In particular, chemical disinfectants may alter membrane material. Moreover, the low temperature resistance of most known membranes makes the use of high temperature disinfection/sterilization reprocessing methods almost impossible.

Additionally, current dialysis therapy typically lasts for about three to four hours per session, and requires approximately three dialysis sessions per week for an average dialysis patient. The relatively long dialysis therapy time and high dialysis session frequency limits the social activities and mobility of dialysis patients.

These and other drawbacks exist with known hemodialysis membranes, dialyzer configurations, and dialysis therapy.

### SUMMARY OF THE INVENTION

The invention solving these and other problems relates to a dialyzer module utilizing a nano-porous ceramic membrane for enhanced hemodialysis performance, and a method for manufacturing the same. The dialyzer module may be utilized in an extracorporeal blood circuit together with pumps, monitors, and/or other components used for dialysis therapy, as known and understood by those having skill in the art.

According to one implementation of the invention, the dialyzer module may comprise an upper chamber, an interior volume, and a lower chamber. One or more nano-porous ceramic tubes may extend from the upper chamber to the lower chamber, through the interior volume. As described in greater detail below, the one or more nano-porous ceramic tubes may comprise the membranes across which the actual process of hemodialysis occurs.

In one implementation, the respective upper ends of the one or more nano-porous ceramic tubes may be secured in place by an upper potting layer such that their openings are in fluid communication with the upper chamber. Similarly, the respective lower ends of the one or more nano-porous ceramic tubes may be secured in place by a lower potting layer such that their openings are in fluid communication with the lower chamber.

In operation, according to one method of use, arterial blood transferred from a patient via a blood pump may enter the upper chamber of the dialyzer module via a blood inlet. The blood may enter openings in the respective upper ends of the one or more nano-porous ceramic tubes, but is otherwise prevented from entering the interior volume of the dialyzer module by the upper potting layer.

Within the interior volume, a dialysate solution introduced via a dialysate inlet is in fluid contact with the one or more nano-porous ceramic tubes. The dialysate solution is prevented from entering the upper and lower chambers of the dialyzer module, however, by the upper and lower potting layers, respectively. As blood flows through the portions of the one or more nano-porous ceramic tubes that extend through the interior volume of the dialyzer module, toxins may be removed from the blood to the dialysate solution via diffusive and convective transport. For instance, uremic solutes may be transferred from the blood to the dialysate solution through the walls of the one or more nano-porous ceramic tubes. The uremic solutes and other toxins in the dialysate solution may then be transported out of the interior volume of the dialyzer module via a dialysate outlet.

The filtered blood may exit from the openings in the respective lower ends of the one or more nano-porous ceramic tubes into the lower chamber, and then out through a blood outlet for return to the body.

According to an aspect of the invention, the one or more nano-porous ceramic tubes that serve as hemodialysis membranes may comprise aluminum oxide (alumina) or titanium oxide (titania) tubes manufactured by the anodization of aluminum (Al) or titanium (Ti) tubes in an appropriate acid solution, using a process described herein. Other ceramic materials may be utilized.

In one implementation, the nano-porous ceramic tubes may be produced with a nano-porous wall structure having an average pore diameter of approximately five to ten nanometers (nm), although other pore diameters (and/or ranges thereof) may be used. The nano-porous ceramic tubes may further exhibit a uniform pore size, uniform pore distribution, high porosity, and high hydraulic conductivity. These characteristics, as described in greater detail herein, provide advantages over the irregular, tortuous pore structure and the wide distribution of pore sizes (of various radii) of the synthetic polymer tubes (or fibers) currently used for hemodialysis. In particular, nano-porous ceramic tubes enable the removal of more middle and large molecular weight solutes to achieve a performance more comparable to that of an actual kidney while, at the same time, reducing the undesirable loss of important macromolecules such as albumin.

An additional advantage of the use of nano-porous ceramic tubes for hemodialysis is that the variation of one or more characteristics during anodization of a ceramic material enables resulting pore sizes to be controlled to some extent. In this regard, membranes may be manufactured for the selective removal of different-sized uremic solutes for different hemodialysis therapies.

Yet another advantage of the invention is that a nano-porous ceramic tube is more rigid than a hollow fiber. This enables an optimum packing density of the one or more nano-porous ceramic tubes (within the dialyzer module body) to be obtained without requiring crimping, which is currently utilized in known hollow fiber dialyzers. Additionally, an optimal packing density enables the dialysate solution to more easily perfuse the areas between the one or more nano-porous ceramic tubes, thus increasing the effective membrane surface area available for mass exchange.

An additional advantage of utilizing nano-porous ceramic tubes rather than polymer hollow fibers is the realization of a more uniform blood flow. The flow rate of blood in a hollow fiber depends on the fourth power of its radius. As such, even a small change in the radius of a fiber may cause a significant impact on the flow rate of blood in the hollow fiber. Unlike the polymer membrane fibers, there is almost no changing of ceramic membrane tube diameter during the assembly. A more uniform blood flow may therefore be realized.

The use of nano-porous ceramic tubes also enables the overall size of the dialyzer module to be smaller than that of current dialyzers. The increased surface area of a nano-porous ceramic tube, for example, enables more blood to come in contact with pores in the ceramic tube, than with a sheet. Additionally, the tight distribution of the pore size of a nano-porous ceramic tube enables the same surface area to be more efficient in the removal of uremic toxins. Moreover, since the surface area of nano-porous ceramic tube is greater, fewer tubes may be necessary to produce the same effect. Therefore, the overall size of the dialyzer module may be decreased, which is, in general, an important step toward making dialysis therapy a more “portable” therapy.

Still yet another advantage of the use of nano-porous ceramic tubes for enhanced hemodialysis performance is that the dialyzer module may enjoy an increased longevity over currently-used dialyzers. In particular, nano-porous ceramic tubes exhibit greater chemical and thermal resistance than do current dialyzer membranes. This enables the use of high temperature disinfection/sterilization techniques not currently utilized for known dialyzer membranes. The overall resilience of the nano-porous ceramic tubes enables reuse over a greater period of time, which may aid significantly in reducing the cost of an average hemodialysis session.

According to one implementation, the dialyzer module may further comprise one or more barriers located within the interior volume. The barriers may be configured to force dialysate solution to flow around more of the nano-porous ceramic tubes, both in the core region and the peripheral region of the interior volume. In addition, the barriers may create turbulent flow within the interior volume of the dialyzer module. This may enable more dialysate solution to come in contact with each of the nano-porous ceramic tubes, thus increasing the dialysate-side mass transfer coefficient by reducing the boundary layer.

Various other objects, features, and advantages of the invention will be apparent through the detailed description of the preferred embodiments and the drawings attached hereto. It is also to be understood that both the foregoing general description and the following detailed description are exemplary and not restrictive of the scope of the invention.

### BRIEF DESCRIPTION OF THE DRAWINGS

FIG. 1 is an exemplary illustration of a dialyzer module, according to an aspect of the invention.

FIG. 2 is an exemplary illustration of a cross-sectional view of a dialyzer module, according to an aspect of the invention.

FIG. 3A depicts a view of an outer surface of a polyethersulfone dialysis membrane.

FIG. 3B illustrates a surface view of a ceramic membrane.

FIG. 4 is an illustration of graph depicting pore size distributions for a ceramic membrane.

FIG. 5 is an exemplary illustration of a dialyzer module, according to an aspect of the invention.

FIG. 6 is an exemplary illustration of a nano-porous ceramic tube extending through a barrier, according to an aspect of the invention.

FIG. 7 is an exemplary illustration of a cross-sectional view of a dialyzer module including at least one barrier, according to an aspect of the invention.

FIG. 8 illustrates an exemplary process of manufacturing operations, according to an aspect of the invention.

### DETAILED DESCRIPTION OF THE PREFERRED EMBODIMENTS

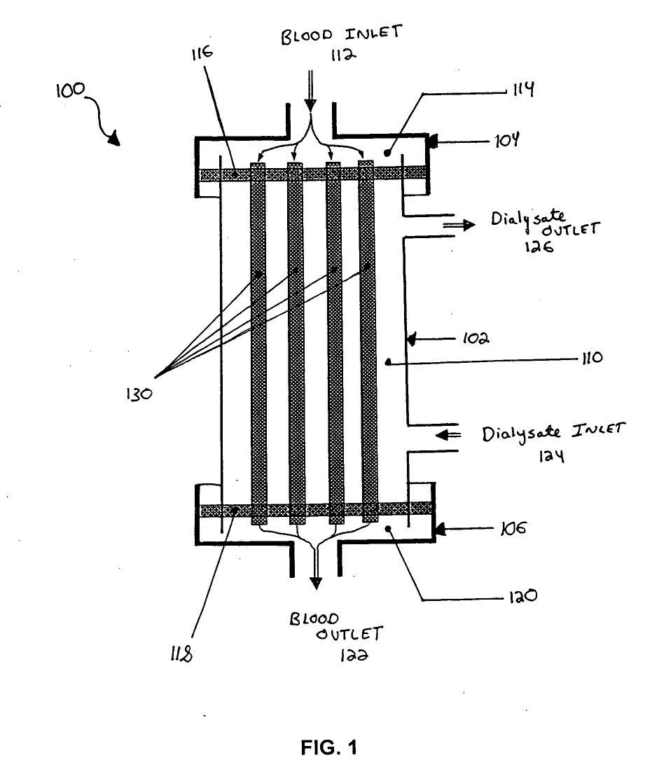

FIG. 1 is an exemplary illustration of a dialyzer module 100, according to an aspect of the invention. Dialyzer module 100 may comprise one portion of an extracorporeal blood circuit together with pumps, monitors, and/or other components (not illustrated) used for dialysis therapy, as known and understood by those having skill in the art.

In one implementation, dialyzer module 100 may comprise a housing that includes an inlet cap 104, module body 102, and outlet cap 106. Inlet cap 104 and outlet cap 106 may be integral with, or removable from, module body 102 as known and understood by those having skill in the art. Inlet cap 104, module body 102, and outlet cap 106 may each be formed from a rigid plastic material, or from other materials commonly used to fabricate similar devices. In some implementations, inlet cap 104 and outlet cap 106 may comprise a first material, while module body 102 comprises a second material. Other variations may be implemented. Further, in some implementations, the material or materials from which inlet cap 104, module body 102, and/or outlet cap 106 are fabricated may be translucent to enable visual inspection of the interior of dialyzer module 100.

According to an aspect of the invention, dialyzer module 100 may comprise an upper chamber 114, an interior volume 110, and a lower chamber 120. Upper chamber 114 may also be referred to as a first chamber, second chamber, third chamber, upstream chamber, inlet chamber, or other chamber. As such, when upper chamber 114 is referred to herein, the term “upper” should not be viewed as limiting. Similarly, lower chamber 120 may also be referred to as a first chamber, second chamber, third chamber, downstream chamber, outlet chamber, or other chamber. As such, when lower chamber 120 is referred to herein, the term “lower” should not be viewed as limiting. Additionally, interior volume 110 may be referred to as an interior chamber, intermediate chamber, first chamber, second chamber, third chamber, dialysate solution chamber, or other chamber or volume. As such the name “interior volume” should not be viewed as limiting.

One or more nano-porous ceramic tubes 130 may extend from upper chamber 114 to lower chamber 120, through interior volume 110. As described in greater detail below, the one or more nano-porous ceramic tubes 130 comprise the membranes across which the actual process of hemodialysis occurs.

In one implementation, the respective upper ends of the one or more nano-porous ceramic tubes 130 may be secured in place by an upper potting layer 116 such that their openings are in fluid communication with upper chamber 114. Upper potting layer 116 may be referred to as a first potting layer, second potting layer, or other potting layer. As such, when upper potting layer 116 is referred to herein, the term “upper” should not be viewed as limiting.

Upper potting layer 116 may comprise a polyurethane potting material, a molten resin potting material, an epoxy resin, or other potting material. In one implementation, the respective upper ends of the one or more nano-porous ceramic tubes 130 may be arranged such that their openings are spaced equidistantly. The openings of the respective upper ends of the one or more nano-porous ceramic tubes 130 may be flush with the top surface of upper potting layer 116. In an alternative implementation, the respective upper ends of the one or more nano-porous ceramic tubes 130 may extend slightly through upper potting layer 116 such that their openings are not flush with the top surface of upper potting layer 116. As illustrated, upper potting layer 116 further serves to separate (or isolate) upper chamber 114 from interior volume 110.

In one implementation, the respective lower ends of the one or more nano-porous ceramic tubes 130 may be secured in place by a lower potting layer 118 such that their openings are in fluid communication with lower chamber 120. Lower potting layer 118 may be referred to as a first potting layer, second potting layer, or other potting layer. As such, when lower potting layer 118 is referred to herein, the term “lower” should not be viewed as limiting.

Lower potting layer 118 may likewise comprise a polyurethane potting material, a molten resin potting material, an epoxy resin, or other potting material. In one implementation, the respective lower ends of the one or more nano-porous ceramic tubes 130 may be arranged such that their openings are spaced equidistantly. The openings of the respective lower ends of the one or more nano-porous ceramic tubes 130 may be flush with the bottom surface of lower potting layer 118. Alternatively, the respective lower ends of the one or more nano-porous ceramic tubes 130 may extend slightly through lower potting layer 118 such that their openings are not flush with the bottom surface of lower potting layer 118. As depicted, lower potting layer 1 18 serves to separate (or isolate) interior volume 110 from lower chamber 120.

In operation, according to one method of use, blood transferred from a patient via a blood pump may enter upper chamber 114 via a blood inlet 112. Blood inlet 112 may be integral with inlet cap 104. The blood may enter openings in the respective upper ends of the one or more nano-porous ceramic tubes 130, but is prevented from entering interior volume 110 directly by upper potting layer 116.

Within interior volume 110, a dialysate solution introduced via a dialysate inlet 124 is in fluid contact with the one or more nano-porous ceramic tubes 130. The dialysate solution may comprise a mixture of electrolytes such as sodium, potassium, calcium, magnesium, chloride, acetate and dextrose. Other dialysate solutions may be utilized. As blood flows through the portions of the one or more nano-porous ceramic tubes 130 that extend through interior volume 110, toxins may be removed from the blood to the dialysate solution via diffusive and convective transport. For instance, uremic solutes may be transferred from the blood to the dialysate solution through the walls of the one or more nano-porous ceramic tubes 130. The uremic solutes (and other toxins) in the dialysate solution may then be transported out of interior volume 110 via a dialysate outlet 126. The dialysate solution is prevented from entering lower chamber 120 by lower potting layer 118.

The filtered blood may exit from the openings in the respective lower ends of the one or more nano-porous ceramic tubes 130 into lower chamber 120, and then out through blood outlet 122 for return to the body. Blood outlet 122 may be integral with outlet cap 106.

According to one implementation of the invention, blood inlet 112, blood outlet 122, dialysate inlet 124, and dialysate outlet 126 may be fabricated from any suitable surgical grade, bio-compatible materials such as, for example, stainless steel, ceramics, titanium, or plastics. Other materials may be utilized.

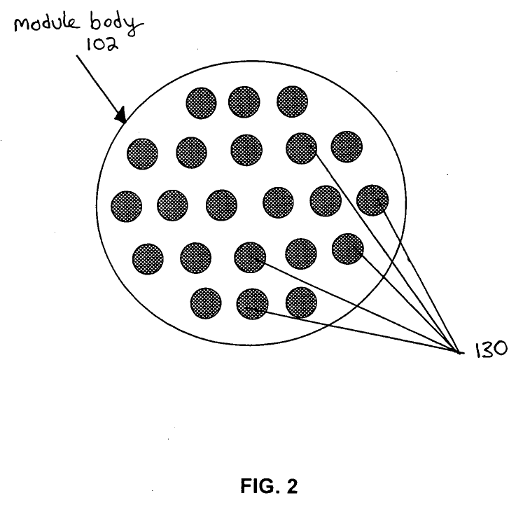

FIG. 2 is an exemplary illustration of a cross-section of dialyzer module 100 taken at a point along module body 102, according to an aspect of the invention. The number of nano-porous ceramic tubes 130 may vary depending on the surface area of membrane desired. As shown, dialyzer module 100 may have a cylindrical cross-section, although any number of shapes having different cross-sections may be utilized.

The configuration of dialyzer module 100 enables enhanced hemodialysis performance, as will now be explained. In particular, as described above, dialyzer module 100 utilizes one or more nano-porous ceramic tubes 130 as the membranes across which the actual process of hemodialysis occurs. Each nano-porous ceramic tube 130 may have a diameter of approximately 0.2-5 mm, although other diameters may be used. Dialyzer module 100 may comprise approximately twenty nano-porous ceramic tubes 130, although any number of nano-porous ceramic tubes may be used. The nano-porous ceramic tubes 130 may be produced with a nano-porous wall structure having an average pore diameter of approximately five to ten nanometers (nm), although other pore diameters (and/or ranges thereof) may be used.

The uniform pore size, uniform pore distribution, high porosity, and high hydraulic conductivity of the one or more nano-porous ceramic tubes 130 may enhance hemodialysis performance by, among other things, improving uremic solute removal while, at the same time, reducing the undesirable loss of important macromolecules such as albumin. For example, the rate of convective solute removal can be modified either by changes in the rate of solvent (plasma water) flow or by changes in the mean effective pore size of the membrane. If a straight cylindrical pore model is considered, the fluid flow along the length of a cylinder in many situations is governed by the Hagen-Poiseuille equation:
ΔP=8QμL/πr⁴, or
Q=ΔP/(8 μL/πr⁴);

where ΔP is the pressure gradient across the membrane (transmembrane pressure);

Q is the flow rate or ultrafiltration rate across the membrane;

L is the length of pore channel;

μ is viscosity; and

r is the radius of pore.

Thus, the rate of ultrafiltration is directly related to the fourth-power of the pore radius at a constant trans-membrane pressure or, in other words, the convective transfer of solute is determined by fourth-power of the pore radius. Therefore, the more uniform and regular pore size membrane, the higher rate convective transfer of middle and large MW solutes can be achieved.

According to an aspect of the invention, the one or more nano-porous ceramic tubes 130 may comprise aluminum oxide (alumina) or titanium oxide (titania) tubes manufactured by the anodization of aluminum (Al) or titanium (Ti) tubes in an appropriate acid solution. Other ceramic materials may be utilized.

In one implementation, to manufacture an alumina tube, a high-purity aluminum tube may be used as a starting material. Prior to anodization, the high-purity aluminum tube may be degreased with an acetone solution, rinsed with deionized water, and dried with N₂ gas.

In addition to physical cleaning, a chemical electro-polishing method (e.g., a mixture of HClO₄ and C₂H₅OH with an applied voltage of approximately 5-8 V for approximately 1-2 minutes) is used to deep clean the surface of the high-purity aluminum tube. After these cleaning steps, the sample should have a shiny, smooth surface.

The aluminum tube may then be mounted on copper wires that serve as an anode, and a graphite foil that serves as a cathode. The exterior surface of the aluminum tube may be covered with a polymeric material so that oxidization may only occur at the interior of the tube. Constant voltage may be applied throughout the anodization process.

To make the porous structures more regular and uniform, a first anodization may be conducted for approximately two hours using an appropriate acid solution and voltage such as, for example, 5% sulfuric acid at 15V applied voltage. This may be followed by etching in a mixture of chromic and phosphoric acid at approximately 60° C. for a predetermined time period (e.g., approximately 1 hour) to remove the porous alumina layer formed in the first anodization. The resulting surface of the remaining aluminum comprises ordered hole arrays due to a barrier layer structure formed at the bottom of the alumina pores.

Anodization of the remaining aluminum layer (under the same conditions used in the first step) yields a nano-porous array with better uniformity and straightness (e.g., in a linear orientation perpendicular to the tube wall surface). With the drop of current and change of the film color (e.g., to light brown), a complete transformation of Al to Al₂O₃ is accomplished. Anodization of the remaining aluminum layer typically requires approximately 1 to 4 days of anodization time. The whole process may be completed at a temperature of approximately 0° C.

After final anodization, the remaining aluminum may be removed in a saturated HgCl₂ solution. Because HgCl₂ can be toxic, alternative solutions may be used for the removal of the aluminum including, for example, a CuCl₂ solution. Other solutions may also be utilized. Subsequently, chemical etching in approximately 5 wt % aqueous phosphoric acid at approximately 40° C. for approximately 10-20 minutes removes the barrier layer and opens the base of the pores.

According to an aspect of the invention, the formation procedure of nano-porous titanium oxide tubing is similar to that of aluminum oxide as described above, except that a different electrolyte may be used. The acid used for titanium oxidization may comprise hydrofluoric acid, and the wall thickness of titanium oxide is generally independent of the duration of the anodizing process.

The foregoing processes are exemplary in nature and, as such, should not be viewed as limiting. Other known or subsequently developed techniques for manufacturing nano-porous ceramic tubes having an average pore diameter of approximately 5 to 10 nm (or other pore diameters or ranges thereof) may be utilized for the manufacture of the one or more nano-porous ceramic tubes 130.

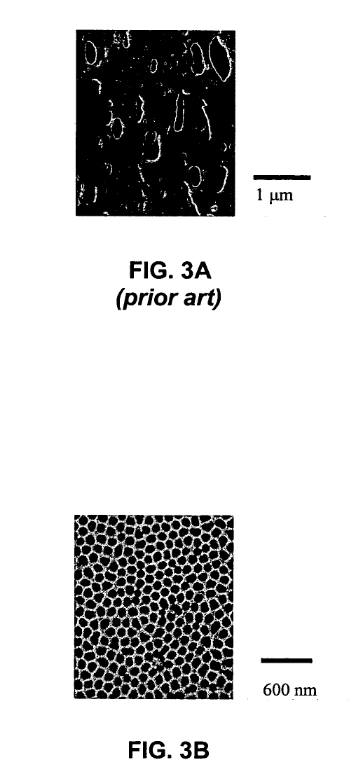

FIG. 3A depicts a view of an outer surface of a polyethersulfone (e.g., a synthetic polymer) dialysis membrane. This figure illustrates the irregular, tortuous pore structure and the wide distribution of pore sizes (of various radii). These characteristics result in a decreased ability to effectively remove middle and large molecular weight solutes from the blood during hemodialysis, while allowing desirable macromolecules such as albumin (an important blood component) to be lost.

FIG. 3B, by contrast, is an illustration of a surface view of a ceramic membrane anodized by 2.7% oxalic acid at 0° C. with a voltage of 50V. While the surface view of the ceramic membrane depicted in FIG. 3B is of a sheet and not a tube, the figure clearly illustrates that the pore sizes appear uniformly circular, and that most pores appear regular in shape. The uniform pore size, high porosity, and high hydraulic conductivity of the membrane may enable removal of more middle and large molecular weight solutes to achieve a performance more comparable to that of an actual kidney.

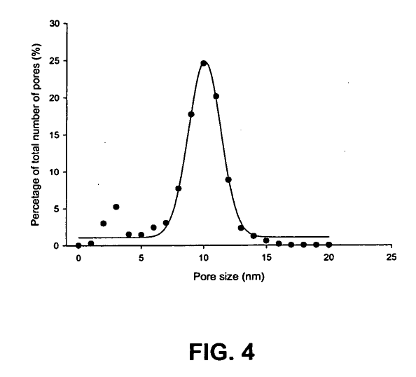

FIG. 4 depicts pore size distributions for a ceramic membrane (also a sheet) produced with 3% sulfuric acid and 17.5V. As illustrated, the pores were tightly distributed around 10 nm. This narrow pore size distribution of the ceramic membrane produced a sharp solute molecular cut-off. Thus, its use in hemodialysis would be effective in the prevention of the loss of macromolecules such as albumin (approximately 7 nm in diameter). Current dialysis membranes have a very broad pore size distribution and therefore cannot target specific sizes of macromolecules to eliminate or keep in the blood, especially albumin.

The variation of one or more characteristics during anodization of a ceramic material enables pore size to be controlled to some extent. For example, the pore radius increases linearly with increasing applied voltage during anodizing. Additionally, at a given voltage, a stronger electrolyte acid solution will result in a smaller pore radius. In this regard, membranes may manufactured for the selective removal of different-sized uremic solutes for different hemodialysis therapies.

The use of one or more nano-porous ceramic tubes as the membrane across which the actual process of hemodialysis occurs provides many advantages over the densely-packed hollow fibers currently utilized in dialyzers.

For instance, a nano-porous ceramic tube is more rigid than a hollow fiber. With reference to FIG. 1, this enables an optimum packing density of the one or more nano-porous ceramic tubes 130 (within module body 102) to be obtained without requiring crimping, which is currently utilized in known hollow fiber dialyzers. Additionally, an optimal packing density enables the dialysate solution to more easily perfuse the areas between the one or more nano-porous ceramic tubes 130 (e.g., FIG. 2), thus increasing the effective membrane surface area available for mass exchange.

Moreover, the flow rate of blood in a hollow fiber depends on the fourth power of its radius. As such, even a small change in the radius of a fiber may cause a significant impact on the flow rate of blood in the hollow fiber. Unlike the polymer membrane fibers, there is almost no changing of ceramic membrane tube diameter during the assembly. A more uniform blood flow may therefore be realized.

The use of nano-porous ceramic tubes 130 also enables the overall size of dialyzer module 100 to be smaller than that of current dialyzers. For instance, the increased surface area of a nano-porous ceramic tube enables more blood to come in contact with pores in the ceramic tube, than with a sheet. Additionally, the tight distribution of the pore size of a nano-porous ceramic tube enables the same surface area to be more efficient in the removal of uremic toxins. Furthermore, since the surface area of nano-porous ceramic tube is greater, fewer tubes may necessary to produce the same effect. Therefore, the overall size of dialyzer module 100 may be decreased. Providing a smaller dialyzer module is an important step toward making dialysis therapy, in general, a more “portable” therapy.

Dialyzer module 100 may enjoy an increased longevity over currently-used dialyzers for at least the reason that the one or more nano-porous ceramic tubes 130 exhibit greater chemical and thermal resistance than do current dialyzer membranes. This enables the use of high temperature disinfection/sterilization techniques not currently utilized for known dialyzer membranes. The overall resilience of the one or more nano-porous ceramic tubes 130 enables reuse over a greater period of time, which may aid significantly in reducing the cost of an average hemodialysis session.

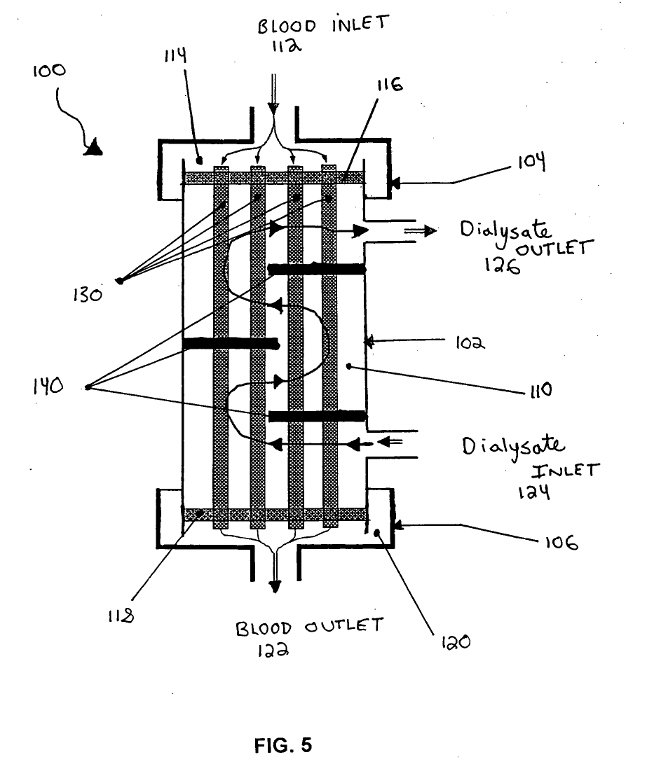

In one implementation of the invention, as illustrated in FIG. 5, dialyzer module 100 may further comprise one or more barriers 140 located within interior volume 110. Barriers 140 may be configured to force the dialysate solution to flow around more of the nano-porous ceramic tubes 130, both in the core region and the peripheral region of interior volume 110. In addition, barriers 140 may create turbulent flow within interior volume 110. This may enable more dialysate solution to come in contact with each of the one or more nano-porous ceramic tubes 130, thus increasing the dialysate-side mass transfer coefficient by reducing the boundary layer.

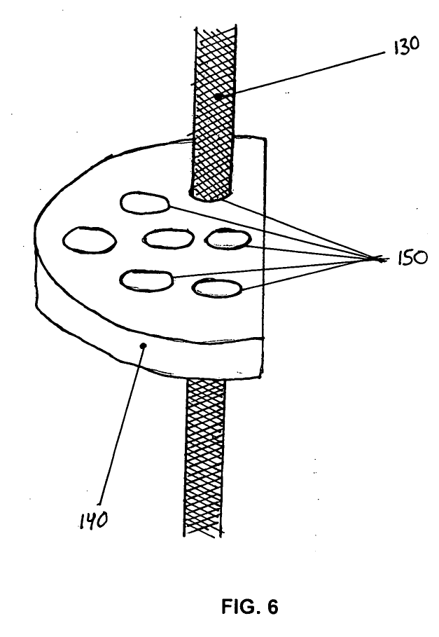

According to an embodiment illustrated in FIG. 6, a barrier 140 may comprise one or more holes 150 extending through to receive one or more nano-porous ceramic tubes 130. In addition to the upper potting layer 116 and lower potting layer 118, described in detail above, the one or more barriers 140 may serve to further stabilize the one or more nano-porous ceramic tubes 130, resulting in a more durable dialyzer module 100.

In one implementation, the one or more barriers 140 may comprise a polymeric material such as an epoxy resin, or other rigid and thermally resistant polymer. As illustrated in FIG. 6, each barrier 140 may comprise a half-moon (or other) shape so as to conform to the shape of module body 102. In this regard, each barrier 140 may not be completely circular so as to allow the dialysate solution to pass around the barrier. Other shapes may be utilized.

The thickness of each barrier 140 may range from approximately 1 to 10 mm, although other thicknesses may be used. Barriers within (or close to) this range of thicknesses may be thick enough so that the barrier will not collapse or deflect, but also thin enough to reduce contact with the surface of a nano-porous ceramic tube 130.

In one implementation, the one or more barriers 140 may be manufactured so as to be integral with the nano-porous ceramic tubes 130 using known manufacturing techniques such as, for example, injection molding. The collective assembly of the one or more barriers 140 and nano-porous ceramic tubes 130 may then be inserted into module body 102, and upper and lower potting layers (116, 118) may be formed to secure the collective assembly in place.

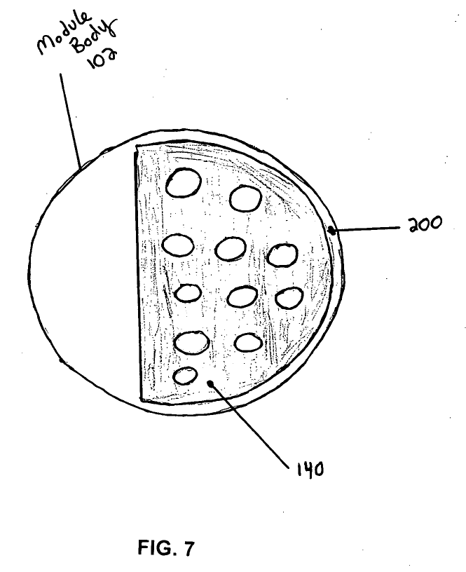

FIG. 7 is an exemplary illustration of a cross-sectional view of a barrier 140 within module body 102 (of dialyzer module 100). For ease of explanation and illustration, only one barrier 140 is shown and no nano-porous ceramic tubes 130 are present. As depicted, barrier 140 may extend over half the diameter of module body 102. In one implementation, for example, barrier 140 may extend approximately two-thirds of the diameter of module body 102 thus acting as a partial barrier for the flow of dialysate solution. In some implementations, barrier 140 may not be flush (or integral) with the inner wall of module body 102. Rather, when the collective assembly of the one or more barriers 140 and nano-porous ceramic tubes 130 are placed within module body 102, a small channel 200 (see FIG. 7) may exist between barrier 140 and the inner wall of module body 102 to prevent the stagnant flow of dialysate solution close to the wall of module body 102.

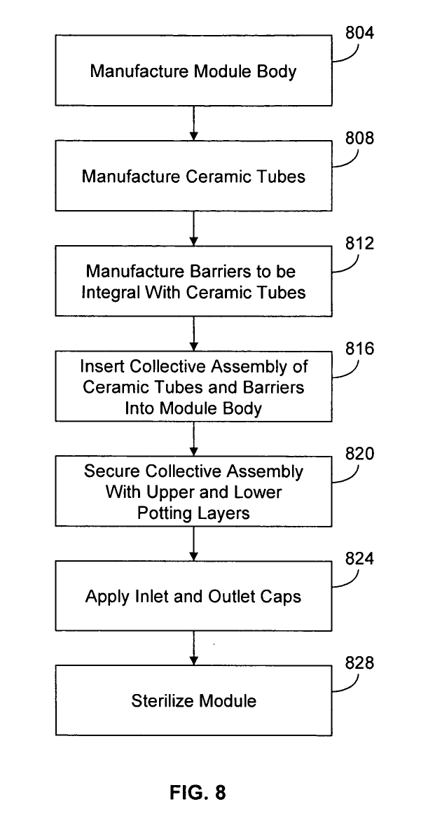

FIG. 8 illustrates an exemplary process of manufacturing operations, according to an embodiment of the invention. In some implementations, various operations may be performed in different sequences (e.g., operation 808 as described herein may occur prior to operation 804). In other implementations, additional operations may be performed along with some or all of the operations shown in FIG. 8. In yet other implementations, one or more operations may be performed simultaneously. Accordingly, the operations described are exemplary in nature and, as such, should not be viewed as limiting.

In an operation 804, module body 102 may be manufactured. The one or more nano-porous ceramic tubes 130 may be manufactured, in an operation 808, using the processes described in detail above. In an operation 812, the one or more barriers 140 may be manufactured so as to be integral with the nano-porous ceramic tubes 130 using known manufacturing techniques such as, for example, injection molding. In an operation 816, the collective assembly of the one or more barriers 140 and nano-porous ceramic tubes 130 may be inserted into module body 102. Upper and lower potting layers (116, 118) may be formed to secure the collective assembly in place, in an operation 820. In an operation 824, inlet cap 104 and outlet cap 106 may be secured to module body 102 to complete dialyzer module 100. As recited above, inlet cap 104 and outlet cap 106 may be integral with, or removable from, module body 102. In an operation 828, dialyzer module 100 may be sterilized prior to use.

Other embodiments, uses and advantages of the invention will be apparent to those skilled in the art from consideration of the specification and practice of the invention disclosed herein. The specification should be considered exemplary only, and the scope of the invention is accordingly intended to be limited only by the following claims.

What is claimed is:

1. A dialyzer module, comprising:
a housing that includes a first chamber having a blood inlet, a second chamber having a blood outlet, and an interior volume that is disposed between, but not in fluid contact with, the first chamber and the second chamber, the interior volume having a dialysate inlet and a dialysate outlet for respectively introducing and removing a dialysate solution to and from the interior volume; and
at least one nano-porous ceramic tube that extends from the first chamber to the second chamber through the interior volume of the housing, wherein the at least one nano-porous ceramic tube includes a first open end in fluid contact with the first chamber and a second open end in fluid contact with the second chamber so that blood introduced into the first chamber via the blood inlet can flow from the first chamber to the second chamber via the at least one nano-porous ceramic tube, the at least one nano-porous ceramic tube having a portion between the first open end and the second open end that is in fluid contact with the interior volume of the housing;
whereby, as blood flows from the first chamber to the second chamber through the at least one nano-porous ceramic tube, toxins are filtered from the blood to the dialysate solution along the portion of the at least one nano-porous ceramic tube that is in fluid contact with the interior volume of the housing.

2. The dialyzer module of claim 1, wherein the housing is a cylindrical housing.

3. The dialyzer module of claim 1, wherein the first chamber is separated from the interior volume via a first potting layer, and the second chamber is separated from the interior volume via a second potting layer.

4. The dialyzer module of claim 3, wherein a first end of the at least one nano-porous ceramic tube is secured in place by the first potting layer such that the first open end of the at least one nano-porous ceramic tube is in fluid contact with the first chamber, and wherein a second end of the at least one nano-porous ceramic tube is secured in place by the second potting layer such that the second open end of the at least one nano-porous ceramic tube is in fluid contact with the second chamber.

5. The dialyzer module of claim 1, wherein the at least one nano-porous ceramic tube is an aluminum oxide tube.

6. The dialyzer module of claim 1, wherein the at least one nano-porous ceramic tube is a titanium oxide tube.

7. The dialyzer module of claim 1, wherein the at least one nano-porous ceramic tube has a diameter of approximately 0.2-5 mm.

8. The dialyzer module of claim 1, wherein the at least one nano-porous ceramic tube has a nano-porous wall structure having an average pore diameter of approximately 5-10 nanometers.

9. The dialyzer module of claim 1, wherein the at least one nano-porous ceramic tube comprises a plurality of nano-porous ceramic tubes.

10. The dialyzer module of claim 1, wherein at least one partial barrier is disposed within the interior volume of the housing.

11. The dialyzer module of claim 10, wherein the at least one partial barrier has a thickness of approximately 1-10 mm.

12. The dialyzer module of claim 10, wherein the at least one partial barrier has a hole through which the at least one nano-porous ceramic tube passes.

13. The dialyzer module of claim 12, wherein the at least one partial barrier is integrally formed with the at least one nano-porous ceramic tube.

14. The dialyzer module of claim 10, wherein the housing is a cylindrical housing, and wherein the at least one partial barrier has a length that is greater than half the diameter of the cylindrical housing.

15. The dialyzer module of claim 14, wherein the at least one partial barrier is separated from an inner wall of the cylindrical housing to allow flow of the dialysate solution there-between.

16. A dialyzer module, comprising:
a housing that includes a first chamber having a blood inlet, a second chamber having a blood outlet, and an interior volume that is disposed between, but not in fluid contact with, the first chamber and the second chamber, the interior volume having a dialysate inlet and a dialysate outlet for respectively introducing and removing a dialysate solution to and from the interior volume;
a plurality of nano-porous ceramic tubes extending from the first chamber to the second chamber through the interior volume of the housing, wherein each of the plurality of nano-porous ceramic tubes includes a first open end in fluid contact with the first chamber and a second open end in fluid contact with the second chamber so that blood introduced into the first chamber via the blood inlet can flow from the first chamber to the second chamber via the plurality of nano-porous ceramic tubes, each of the plurality of nano-porous ceramic tubes having a portion between the first open end and the second open end that is in fluid contact with the interior volume of the housing; and
one or more partial barriers disposed within the interior volume of the housing that direct, in part, flow of the dialysate solution in the interior volume of the housing to increase fluid contact between the dialysate solution and the portion of each of the plurality of nano-porous tubes that is in fluid contact with the interior volume of the housing;
whereby, as blood flows from the first chamber to the second chamber through each of the plurality of nano-porous ceramic tubes, toxins are filtered from the blood to the dialysate solution along the portion of each of the plurality of nano-porous ceramic tubes that is in fluid contact with the interior volume of the housing.

17. The dialyzer module of claim 16, wherein the housing is a cylindrical housing.

18. The dialyzer module of claim 16, wherein the first chamber is separated from the interior volume via a first potting layer, and the second chamber is separated from the interior volume via a second potting layer.

19. The dialyzer module of claim 16, wherein each of the plurality of nano-porous ceramic tubes is an aluminum oxide tube.

20. The dialyzer module of claim 16, wherein each of the plurality of nano-porous ceramic tubes is a titanium oxide tube.

21. The dialyzer module of claim 16, wherein each of the plurality of nano-porous ceramic tubes has a diameter of approximately 0.2-5 mm.

22. The dialyzer module of claim 16, wherein each of the plurality of nano-porous ceramic tubes has a nano-porous wall structure having an average pore diameter of approximately 5-10 nanometers.

23. The dialyzer module of claim 16, wherein each of the one or more partial barriers has a thickness of approximately 1-10 mm.

24. The dialyzer module of claim 16, wherein each of the one or more partial barriers has one or more holes for enabling one or more of the plurality of nano-porous ceramic tubes to pass there-through.

25. The dialyzer module of claim 24, wherein each of the one or more partial barriers is integrally formed with the one or more of the plurality of nano-porous ceramic tubes that pass there-through.

26. The dialyzer module of claim 16, wherein the housing is a cylindrical housing, and wherein each of the one or more partial barriers has a length that is greater than half the diameter of the cylindrical housing.

27. The dialyzer module of claim 26, wherein each of the one or more partial barriers is separated from an inner wall of the cylindrical housing to allow flow of the dialysate solution between each of the one or more partial barriers and the inner wall of the cylindrical housing.

28. A method of performing hemodialysis, comprising:
receiving arterial blood from a subject in a first chamber of a housing via a blood inlet, the housing further comprising a second chamber having a blood outlet, and an interior volume that is disposed between, but not in fluid contact with, the first chamber and the second chamber;
passing the arterial blood through at least one nano-porous ceramic tube that extends from the first chamber to the second chamber through the interior volume of the housing, wherein the at least one nano-porous ceramic tube includes a first open end in fluid contact with the first chamber, a second open end in fluid contact with the second chamber, and a portion between the first open end and the second open end that is in fluid contact with the interior volume of the housing;
introducing a dialysate solution into the interior volume of the housing such that, as blood flows from the first chamber to the second chamber through the at least one nano-porous ceramic tube, toxins are filtered from the blood to the dialysate solution, via diffusion, along the portion of the at least one nano-porous ceramic tube that is in fluid contact with the interior volume of the housing; and
passing filtered blood out of the blood outlet of the second chamber for return to the subject's venous system.

29. The method of claim 28, wherein the at least one nano-porous ceramic tube is an aluminum oxide tube.

30. The method of claim 28, wherein the at least one nano-porous ceramic tube is a titanium oxide tube.

31. The method of claim 28, wherein the at least one nano-porous ceramic tube has a diameter of approximately 0.2-5 mm.

32. The method of claim 28, wherein the at least one nano-porous ceramic tube has a nano-porous wall structure having an average pore diameter of approximately 5-10 nanometers.

33. The method of claim 28, wherein the at least one nano-porous ceramic tube comprises a plurality of nano-porous ceramic tubes.

34. A method of performing hemodialysis, comprising:
passing arterial blood from a subject through at least one nano-porous ceramic tube, the at least one nano-porous ceramic tube extending through an interior volume of a housing that includes a dialysate solution such that, as the blood flows through the at least one nano-porous ceramic tube, toxins are filtered from the blood to the dialysate solution via diffusion; and
returning filtered blood to the subject's venous system.

35. The method of claim 34, wherein the at least one nano-porous ceramic tube is an aluminum oxide tube.

36. The method of claim 34, wherein the at least one nano-porous ceramic tube is a titanium oxide tube.

37. The method of claim 34, wherein the at least one nano-porous ceramic tube has a diameter of approximately 0.2-5 mm.

38. The method of claim 34, wherein the at least one nano-porous ceramic tube has a nano-porous wall structure having an average pore diameter of approximately 5-10 nanometers.
